(19) United States
(12) Patent Application Publication
(10) Pub. No.: US 2024/0328265 A1
(43) Pub. Date: Oct. 3, 2024

(54) METHOD AND SYSTEM FOR DETERMINING SHALE SHAKER SELECTION USING DRILLING DATA AND MACHINE LEARNING

(71) Applicant: SAUDI ARABIAN OIL COMPANY, Dhahran (SA)

(72) Inventor: Ahmed I. Saihati, Saihat (SA)

(73) Assignee: SAUDI ARABIAN OIL COMPANY, Dhahran (SA)

(21) Appl. No.: 18/193,304

(22) Filed: Mar. 30, 2023

(51) Int. Cl. E21B 21/06; B07B 1/42; E21B 21/08; E21B 44/00; E21B 45/00; E21B 49/00

(52) U.S. Cl. CPC E21B 21/065; B07B 1/42; E21B 21/08; E21B 44/00; E21B 45/00; E21B 49/00; E21B 2200/22

(57) ABSTRACT

A method involves obtaining surface drilling data for a drilling operation at a wellbore, obtaining drilling fluid data regarding a drilling fluid in the wellbore during the drilling operation, obtaining drilling fluid hydraulic data regarding a drilling fluid device that causes the drilling fluid to circulate in the wellbore, obtaining geological data regarding one or more formations being traversed by the drilling operation, generating, predicted particle size data of cuttings in the drilling fluid using a machine-learning model, the surface drilling data, the drilling fluid data, the drilling fluid hydraulic data, and the geological data, and determining a shaker screen type based on the predicted particle size data. The method also involves transmitting a first command to a well control system, the first command being configured to change a first shaker screen to a second shaker screen in a shale shaker device based on the shaker screen type.

### BACKGROUND

Drilling fluid, also called drilling mud or simply mud, may be a heavy, viscous fluid mixture that is used in oil and gas drilling operations to carry rock cuttings from a wellbore back to the surface. Drilling mud may also be used to lubricate and cool a drill bit. The drilling fluid, by hydrostatic pressure, may also assist in preventing the collapse of unstable strata into the wellbore as well as the intrusion of water from stratigraphic formations proximate the wellbore.

However, to ensure efficiency and prevent damage to surface equipment and reservoir fluid bearing-zone, the properties of drilling fluids should be maintained in certain conditions. These properties may include solid concentrations/content and particle size. The solid content in the drilling fluid may include soluble solids which are added to the drilling fluid mainly to stabilize the well and form an ideal filter cake to minimize the invasion of fluid into the formation. Hence, reduce oil/gas formation damage. The solid content in drilling fluid may also include insoluble high-gravity solids (HGS), which include weighting agents to achieve and maintain specific densities. Likewise, solid content may also include undesirable insoluble low-gravity solids which are known as drilled solids or drilled cuttings.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, the invention relates to a method comprising obtaining surface drilling data for a drilling operation at a wellbore, obtaining drilling fluid data regarding a drilling fluid in the wellbore during the drilling operation, obtaining drilling fluid hydraulic data regarding a drilling fluid device that causes the drilling fluid to circulate in the wellbore, obtaining geological data regarding one or more formations being traversed by the drilling operation, generating, by a computer processor, predicted particle size data of cuttings in the drilling fluid using a machine-learning model, the surface drilling data, the drilling fluid data, the drilling fluid hydraulic data, and the geological data, determining, by the computer processor, a shaker screen type based on the predicted particle size data, wherein the shaker screen type corresponds to a predetermined cutting size; and transmitting, by the computer processor, a first command to a well control system, wherein the first command being configured to change a first shaker screen to a second shaker screen in a shale shaker device based on the shaker screen type.

In general, in one aspect, the invention relates to a system, comprising a drilling system comprising a drill string and a plurality of sensors, wherein the drilling system is coupled to a wellbore, a mud pump system coupled to the wellbore, wherein the mud pump system is configured to supply a drilling fluid to the wellbore, and a control system coupled to the drilling system and the mud pump system. The control system comprises a computer processor, and is configured to perform a method comprising obtaining surface drilling data for a drilling operation at a wellbore, obtaining drilling fluid data regarding a drilling fluid in the wellbore during the drilling operation, obtaining drilling fluid hydraulic data regarding a drilling fluid device that causes the drilling fluid to circulate in the wellbore, obtaining geological data regarding one or more formations being traversed by the drilling operation, generating predicted particle size data of cuttings in the drilling fluid using a machine-learning model, the surface drilling data, the drilling fluid data, the drilling fluid hydraulic data, and the geological data, determining a shaker screen type based on the predicted particle size data, wherein the shaker screen type corresponds to a predetermined cutting size, and changing a first shaker screen to a second shaker screen in a shale shaker device based on the shaker screen type.

In light of the structure and functions described above, embodiments of the invention may include respective means adapted to carry out various steps and functions defined above in accordance with one or more aspects and any one of the embodiments of one or more aspect described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1, 2, and 3 show systems in accordance with one or more embodiments.

FIG. 4 shows a flowchart in accordance with one or more embodiments.

FIGS. 5A, 5B, and 6 show examples in accordance with one or more embodiments.

FIG. 7 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for determining a predicted particle size of drilling cuttings using machine learning. In particular, excessive low-gravity solids (LGS), such as drilled cuttings, may have an adverse impact on rate of penetration, equivalent circulation density (ECD), and surge/swap pressure during a drilling operation. For example, drilled cuttings may also make a filter cake thick and sticky which increases the possibility of equipment becoming stuck. As such, some embodiments may use a predicted particle size to tailor the corresponding size of a shale shaker screen for effective solid removal. Moreover, a machine-learning model may be trained to predict particle size data using surface drilling data (e.g., rate of penetration values), drilling fluid data (e.g., yield points and plastic viscosity values), drilling fluid hydraulic data (e.g., drilling fluid pressure values), and/or geological data (e.g., lithological data that describes a type of formation being drilled) from similar wells.

Furthermore, “initial drilling fluid” may refer to clean drilling fluid prior to entering a wellbore. Likewise, “initial drilling fluid” may refer to treated or recycled drilling fluid that is acquired from a wellbore and prior to being returned to the wellbore for use in a drilling operation. On the other hand, density data may also be collected for “wellbore drilling fluid”, which may refer to drilling fluid located circulating at one or more segment lengths in a respective wellbore.

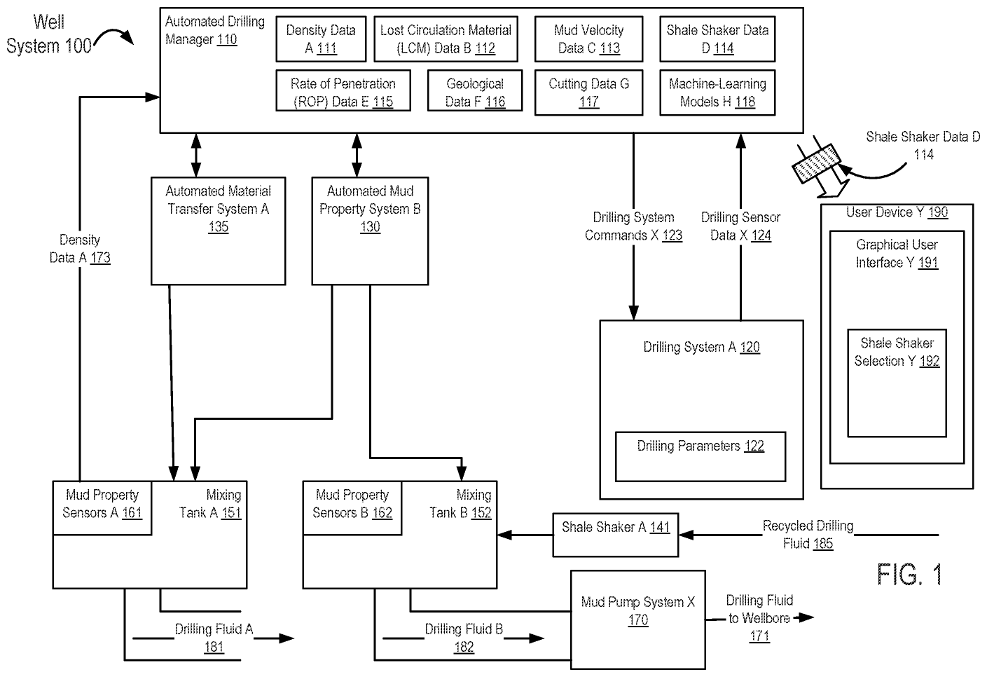

Turning to FIG. 1, FIG. 1 shows a schematic diagram in accordance with one or more embodiments. As shown in FIG. 1, FIG. 1 illustrates a well system (100) that may include an automated drilling manager (e.g., automated drilling manager (110)) coupled to one or more user devices (e.g., user device Y (190)), a drilling system (e.g., drilling system A (120)), a mud pump system (e.g., mud pump system X (170)), an automated material transfer system (e.g., automated material transfer system A (135)), an automated mud property system (e.g., automated mud property system B (130)), and various drilling fluid processing components. For example, drilling fluid processing equipment may include one or more feeders (not shown), one or more control valves (not shown), one or more mixing tanks (e.g., mixing tank A (151), mixing tank B (152)), and a solid removal system (e.g., one or more shale shaker devices, such as shale shaker A (141)). An automated mud property system may include hardware and/or software that includes functionality for monitoring and/or controlling various chemical components used to produce drilling fluid. Likewise, the automated drilling manager may include hardware and/or software for monitoring and/or controlling one or more drilling operations performed by a drilling system.

In some embodiments, cuttings data (e.g., cutting data G (117)) regarding various drill cuttings may be obtained by an automated drilling manager for a drilling fluid circulating in a well. Drill cuttings may include broken bits of solid material removed from a borehole drilled by rotary, percussion, or auger methods and brought to a well surface in drilling fluid. In particular, drill cuttings may be collected by a shale shaker device (e.g., shale shaker A (141)) in order to remove the drill cuttings from recycled drilling fluid. For example, a shale shaker device may include a hopper, a feeder, a screen basket, and an electric motor. Likewise, cutting data may describe particle sizes, particle shapes, and/or particle type (e.g., type of rock) found among drill cuttings. Likewise, cuttings data may also correspond to acquired cutting samples that are sieved for specific cuttings data, such as a particle size distribution (PSD) analysis. More specifically, a particle size distribution may correspond to various distribution values, such as D10, D50, and D90. For example, a D50 value may correspond to a particle size of cuttings in microns that splits the cuttings distribution with half of the cuttings above and half of the cuttings below this diameter within the selected drilling interval of the training well. In other words, a D50 value means 50% of cutting particles are larger than D50 and 50% of the cutting particles are smaller than D50. Likewise, D50 may be used to represent the average particle size in many drilling operations. On the other hand, a D90 value may correspond to 90% of the total cutting particles being smaller than this size. Likewise, a D10 value may correspond to 10% of the total cutting particles being smaller than this size. In some embodiments, any Dx value can be obtained from PSD cutting data depending on the interest of the operator, such as for optimizing a particular shale screen in a solid removal system. Moreover, an automated drilling manager may store shale shaker data (e.g., shale shaker data D (114)) on different types of shale shakers and shale shaker screens in order to select one based on cutting data.

In some embodiments, predicted cuttings data may be determined surface drilling data, geological data, drilling fluid data, and/or drilling fluid hydraulic data for a drilling fluid (e.g., drilling fluid A (181), drilling fluid B (182), recycled drilling fluid (185)) using one or more machine-learning models (e.g., the machine-learning models H (118)). For example, surface drilling data may include various surface drilling parameters data such as flow rate data (Q), rotary speed (RS) data, and weight-on-bit (WOB) data. As such, surface drilling data may be acquired from sensors at a drilling site. Drilling fluid data may include information for various drilling fluid parameters, such as drilling fluid weight (MW), drilling fluid rheology, plastic viscosity (PV), and yield point (Yp). Drilling fluid data may be obtained in real time using a well system, such one that includes mud property sensors as found in a drilling fluid monitoring system. Drilling fluid hydraulic data may correspond to various parameters of one or more mud pump systems, such as bit mechanical horse power (bit MHP), jet impact force (F), and jet velocity (V). Likewise, geological data (e.g., geological data F (116)) may describe various lithology parameters such as formation type or formation name (FM) and various rock drillabilty data (D).

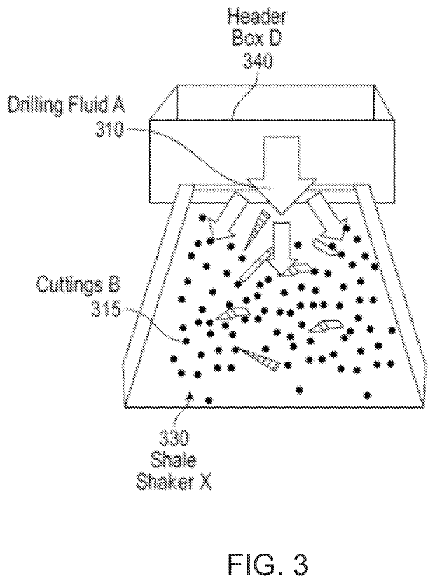

Turning to FIG. 3, FIG. 3 shows a solid removal device in accordance with one or more embodiments. In FIG. 3, a shale shaker (e.g., shale shaker X (330)) may have a surface screen formed in a fine mesh and/or a course mesh that allows drilling fluid (e.g., drilling fluid A (310)) to pass through without the drill cuttings (e.g., cuttings B (315)). The shale shaker may have solids loading, solids discharge, a possum belly (e.g., a metal container at the head of the shale shaker that receives the flow of drilling fluid and is directly connected to and at the end of the flow line), and a header box (e.g., header box D (340)) to facilitate removing the cuttings from cuttings-laden drilling fluid. To clean the cuttings-laden mud, a mud circulation system may use other cleaning apparatus such as a hydrocyclone, a centrifuge, a desander, and/or a desilter. As shown in FIG. 3, drilling fluid may enter a solids control process from a header box, a possum belly, and gravity-feeds into a vibrating basket of the shale shaker. A vibrational impact of drilling fluid with the screen may cause separation between liquid and solid. The solids may be discarded while the drilling fluid and fine solids may pass into a sump tank for further treatment.

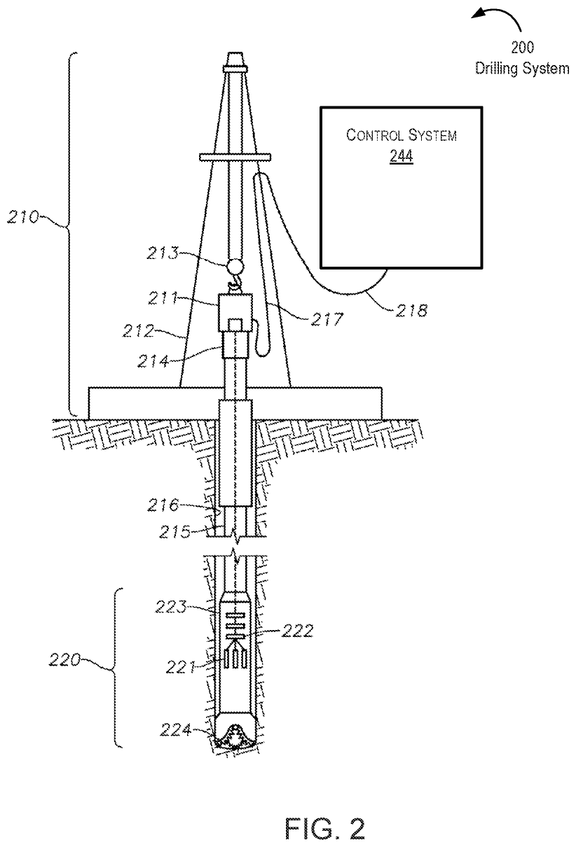

Returning to FIG. 1, with respect to the drilling system, drilling fluid may circulate through a drill string for continuous drilling, e.g., drilling fluid A (181) and drilling fluid B (182) as shown in FIG. 1, in order to circulate through a wellbore (e.g., drilling fluid to wellbore (171)). In particular, the ability of the drilling fluid to carry drilled cuttings from a wellbore may be governed by several factors that relate to various drilling fluid properties (e.g., mud rheology, mud weight, etc.) and various drilling operation parameters (e.g., drilling parameters (122)) such as drill pipe rotary speed (RPM), pipe eccentricity (i.e. axial location of the drill pipe), hole inclination angle, and rate of penetration (ROP) (e.g., ROP data E (115)). Likewise, used drilling fluid from a wellbore may be passed through a solid removal system prior to entering a mixing tank or being sent to a mud pump system. More specifically, a solid removal system may include equipment and other hardware for removing particular solids, such as drill cuttings and coarse aggregates, from used drilling fluid in order to recycle drilling fluid (e.g., recycled drilling fluid (185)). For more information on drilling systems, see FIG. 2 and the accompanying description below.

In some embodiments, an automated drilling manager transmits one or more commands (e.g., drilling system commands X (123)) to various control systems in a well system (e.g., drilling system A (120), automated material transfer system A (135), automated mud property system B (130)) in order to produce drilling operations with specific drilling parameters and/or produce drilling fluids (e.g., drilling fluid A (181), drilling fluid B (182), recycled drilling fluid (185)) having specific drilling fluid properties, such as predetermined density values or mud velocity values. Commands may include data messages transmitted over one or more network protocols using a network interface, such as through wireless data packets. Likewise, a command may also be a control signal, such as an analog electrical signal, that triggers one or more operations in a particular control system (e.g., drilling system A (120)).

Furthermore, drilling fluid data (e.g., density data A (111), lost circulation material (LCM) data B (112), mud velocity data C (113)) may correspond to different physical qualities associated with drilling mud, such as specific gravity values (also referred to as mud weight or mud density), viscosity levels, pH levels, rheological values such as flow rates, temperature values, resistivity values, mud mixture weights, mud particle sizes, mud pressures, mud velocities, and various other attributes that affect the role of drilling fluid in a wellbore. For example, a drilling fluid property may be selected by a user device to have a desired predetermined rheological value, which may include a range of acceptable values, a specific threshold value that should be exceeded, a precise scalar quantity, etc. As such, an automated drilling manager or another control system may obtain sensor data (e.g., density data A (173)) from various mud property sensors (e.g., mud property sensors A (161), mud property sensors B (162)) regarding various drilling fluid property parameters. Examples of mud property sensors include pH sensors, density sensors, rheological sensors, volume sensors, weight sensors, flow meters, such as an ES flow sensor, etc. Likewise, sensor data may refer to both raw sensor measurements and/or processed sensor data associated with one or more drilling fluid properties.

With respect to mud pump systems, a mud pump system (e.g., mud pump system X (170)) may include hardware and software with functionality for supplying drilling fluid to a wellbore at one or more predetermined pressures and/or at one or more predetermined flow rates. For example, a mud pump system may include one or more displacement pumps that inject the drilling fluid into a wellbore. Likewise, a mud pump system may include a pump controller that includes hardware and/or software for adjusting local flow rates and pump pressures, e.g., in response to a command from an automated drilling manager or other control system. For example, a mud pump system may include one or more communication interfaces and/or memory for transmitting and/or obtaining data over a well network. A mud pump system may also obtain and/or store sensor data from one or more sensors coupled to a wellbore regarding one or more pump operations. While a mud pump system may correspond to a single pump, in some embodiments, a mud pump system may correspond to multiple pumps.

With respect to mixing tanks, a mixing tank may be a container or other type of receptacle (e.g., a mud pit) for mixing various liquids, fresh mud, recycled mud (e.g., recycled drilling fluid (185)), additives, and/or other chemicals to produce a particular type of drilling fluid (e.g., drilling fluid A (181), drilling fluid B (182)). For example, a mixing tank may be coupled to one or more mud supply tanks, one or more additive supply tanks, one or more dry/wet feeders, and one or more control for managing the mixing of chemicals within a respective mixing tank. Control valves may be used to meter chemical inputs into a mixing tank, as well as release drilling fluid into a mixing tank. Likewise, a mixing tank may include and/or be coupled to various types of drilling fluid equipment not shown in FIG. 1, such as various mud lines, liquid supply lines, and/or other mixing equipment.

In some embodiments, a well system includes an automated material transfer system (e.g., automated material transfer system A (135)). In particular, an automated material transfer system may be a control system with functionality for managing supplies of bulk powder and other inputs for producing a preliminary mud mixture. For example, an automated material transfer system may include a pneumatic, conveyer belt or a screw-type transfer system (e.g., using a screw pump) that transports material from a supply tank upon a command from a sensor-mediated response. Thus, the automated material transfer system may monitor a mixing tank using weight sensors and/or volume sensors to meter a predetermined amount of bulk powder to a selected mixing tank.

Likewise, a well system may also include an automated mud property system (e.g., automated mud property system B (130)) to control the supply of various additives to a mixing tank. In some embodiments, for example, an automated mud property system may include hardware and/or software with functionality for automatically supplying and/or mixing weighting agents, buffering agents, rheological modifiers, and/or other additives until a mud mixture matches and/or satisfies one or more desired drilling fluid properties. Examples of weighting agents may include barite, hematite, calcium carbonate, siderite, etc. A buffering agent may be a pH buffering agent that causes a mud mixture to resist changes in PH levels. For example, a buffering agent may include water, a weak acid (or weak base) and salt of the weak acid (or a salt of weak base). Rheological modifiers may include drilling fluid additives that adjust one or more flow properties of a drilling fluid. One type of rheological modifier is a viscosifier, which may be an additive with functionality for providing thermal stability, hole-cleaning, shear-thinning, improving carrying capacity as well as modifying other attributes of a drilling fluid. Examples of viscosifiers include bentonite, inorganic viscosifiers, polymeric viscosifiers, low-temperature viscosifiers, high-temperature viscosifiers, oil-fluid liquid viscosifiers, organophilic clay viscosifiers, and biopolymer viscosifiers.

Furthermore, an automated drilling manager may monitor various drilling fluid properties and drilling parameters in real-time. For example, drilling fluid properties may be monitored using one or more mud property sensors. Likewise, drilling parameters may be modified in real-time based on downhole sensors, drilling sensors (e.g., using drilling sensor data X (124)), etc. In some embodiments, for example, the automated drilling manager modifies drilling fluid properties and drilling parameters at predetermined intervals until user-defined properties are achieved by the well system (100). The user-defined properties may correspond to a selection by a user device (e.g., user selection Y (192) obtained by user device Y (190) using a graphical user interface Y (191)). For example, an automated drilling manager may be coupled to a user device e.g., over a well network, or remotely (e.g., through a remote connection using Internet access or a wireless connection at a well site). Based on real-time updates received for a current drilling operation, a user and/or the automated drilling manager may modify previously-selected drilling fluid property values and/or drilling parameters, e.g., in response to changes in drilling fluid within the wellbore.

In some embodiments, the automated drilling manager may include hardware and/or software with functionality for generating and/or using one or more machine-learning models (e.g., machine-learning models H (118)) for analyzing fluid properties and drilling parameters. For example, the automated drilling manager may use and/or process drilling fluid data as well as other types of data to generate and/or update one or more machine-learning models. Thus, different types of machine-learning models may be trained, such as convolutional neural networks, deep neural networks, recurrent neural networks, support vector machines, decision trees, inductive learning models, deductive learning models, supervised learning models, unsupervised learning models, reinforcement learning models, etc. In some embodiments, two or more different types of machine-learning models are integrated into a single machine-learning architecture, e.g., a machine-learning model may include decision trees and neural networks. In some embodiments, the automated drilling manager may generate augmented or synthetic data to produce a large amount of interpreted data for training a particular model.

With respect to neural networks, for example, a neural network may include one or more hidden layers, where a hidden layer includes one or more neurons. A neuron may be a modelling node or object that is loosely patterned on a neuron of the human brain. In particular, a neuron may combine data inputs with a set of coefficients, i.e., a set of network weights and biases for adjusting the data inputs. These network weights and biases may amplify or reduce the value of a particular data input, thereby assigning an amount of significance to various data inputs for a task being modeled. Through machine learning, a neural network may determine which data inputs should receive greater priority in determining one or more specified outputs of the neural network. Likewise, these weighted data inputs may be summed such that this sum is communicated through a neuron's activation function to other hidden layers within the neural network. As such, the activation function may determine whether and to what extent an output of a neuron progresses to other neurons where the output may be weighted again for use as an input to the next hidden layer.

In some embodiments, various types of machine learning may be used to train a model, such as a backpropagation algorithm. In a backpropagation algorithm, gradients are computed for each hidden layer of a neural network in reverse from the layer closest to the output layer proceeding to the layer closest to the input layer. As such, a gradient may be calculated using the transpose of the weights of a respective hidden layer based on an error function (also called a “loss function”). The error function may be based on various criteria, such as mean squared error function, a similarity function, etc., where the error function may be used as a feedback mechanism for tuning weights in the electronic model.

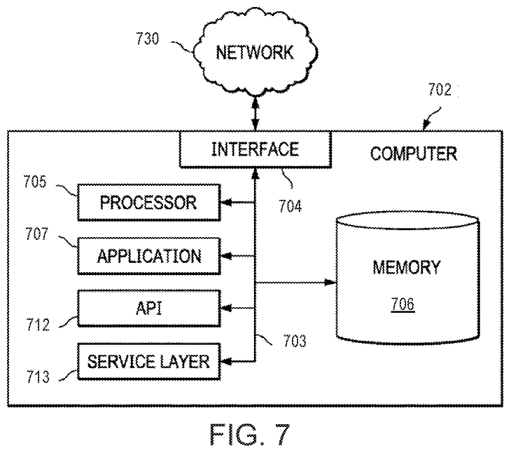

Keeping with FIG. 1, an automated drilling manager, an automated material transfer system, and/or an automated mud property system may include one or more control systems that include one or more programmable logic controllers (PLCs). Specifically, a programmable logic controller may control valve states, fluid levels, pipe pressures, warning alarms, and/or pressure releases throughout a well system. In particular, a programmable logic controller may be a ruggedized computer system with functionality to withstand vibrations, extreme temperatures, wet conditions, and/or dusty conditions, for example, around a drilling rig. In some embodiments, the automated drilling manager (110), the automated material transfer system A (135), the automated mud property system B (130), and/or the user device Y (190) may include a computer system that is similar to the computer system (702) described below with regard to FIG. 7 and the accompanying description.

During some well operations, a lost circulation event may occur that results in a partial or complete loss of drilling fluid and/or cement slurry into a formation. For example, a lost circulation event may be brought on by natural causes or induced causes within the formation. Natural causes may include naturally-occurring fractures or caverns adjacent to a wellbore as well as unconsolidated zones. Induced causes may include a situation when a hydrostatic fluid pressure exceeds a fracture gradient of the formation resulting in a fracture receiving fluid rather than resisting the fluid. When drilling into highly fractured formations, for example, severe fluid losses may be encountered that pose serious threats to drilling operations. Fluid losses may lead to various risks such as high costs of replacing drilling fluid during the drilling operation, formation damage left behind by lost circulation treatments, and even a possible loss of hydrostatic pressure that can cause an influx of gas or fluid, e.g., resulting in a well blowout.

With respect to drilling operations, various types of lost circulation material (LCMs) may be used in a lost circulation treatment to prevent or reduce drilling fluids from being lost inside downhole formations. LCM examples may include fibrous materials (e.g., cedar bark, shredded cane stalks, mineral fiber, and hair), flaky materials (e.g., mica flakes, pieces of plastic, and cellophane sheeting) or granular materials (e.g., ground and sized materials such as limestone, marble, wood, nut hulls, Formica, corncobs, and cotton hulls). A fibrous LCM may include long, slender and flexible substances that are insoluble and inert, where the fibrous material may assist in retarding drilling fluid loss into fractures or highly permeable zones. A flaky LCM may be thin and flat in shape with a large surface area in order to seal off fluid loss zones in a wellbore and help stop lost circulation. A granular LCM may be chunky in shape with a range of particle sizes. LCMs may also include one or more bridging agents that may include solids added to a drilling fluid to bridge across a pore throat or fractures of an exposed rock thereby producing a filter cake to prevent drilling fluid loss or excessive filtration.

Example bridging agents may include removable-common products include calcium carbonate (acid-soluble), suspended salt (water-soluble) or oil-soluble resins. In some embodiments, granular materials, flaky materials, and/or fibrous materials are combined into an LCM pill and pumped into a wellbore next to a zone experiencing fluid loss to seal the formation.

In regard to automated mud processing systems, an automated mud processing system may include a controller coupled various feeders, various control valves, various mixing tanks, and/or a solid removal system for managing drilling fluid in a drilling operation. The controller may include hardware, such as a processor, coupled to various sensors around various well systems at a well site. With respect to a mixing tank, a mixing tank may be a container or other type of receptacle (e.g., a mud pit) for mixing various liquids, fresh mud, recycled mud, different types of LCMs, additives, and/or other chemicals to produce a particular drilling fluid mixture. For example, a mixing tank may be coupled to one or more mud supply tanks, one or more additive supply tanks, one or more dry/wet feeders, and one or more control valves for managing the mixing of chemicals within a respective mixing tank. Control valves may be used to meter chemical inputs into a mixing tank, as well as release drilling fluid into a mixing tank.

Turning to FIG. 2, FIG. 2 illustrates a system in accordance with one or more embodiments. As shown in FIG. 2, a drilling system (200) may include a top drive drill rig (210) arranged around the setup of a drill bit logging tool (220). A top drive drill rig (210) may include a top drive (211) that may be suspended in a derrick (212) by a travelling block (213). In the center of the top drive (211), a drive shaft (214) may be coupled to a top pipe of a drill string (215), for example, by threads. The top drive (211) may rotate the drive shaft (214), so that the drill string (215) and a drill bit logging tool (220) cut the rock at the bottom of a wellbore (216). A power cable (217) supplying electric power to the top drive (211) may be protected inside one or more service loops (218) coupled to a control system (244). As such, drilling fluid may be pumped into the wellbore (216) using the drive shaft (214) and/or the drill string (215). Likewise, the drilling system may also include a mud pump, a mud line, mud pits, a mud return, and other components related to the circulation or recirculation of drilling fluid within the wellbore (216). The control system (244) may be similar to various control systems described above in FIG. 1 and the accompanying description, such as the automated drilling manager (110), the automated material transfer system A (135) and/or the automated mud property system B (130).

Moreover, when completing a well, casing may be inserted into the wellbore (216). The sides of the wellbore (216) may require support, and thus the casing may be used for supporting the sides of the wellbore (216). As such, a space between the casing and the untreated sides of the wellbore (216) may be cemented to hold the casing in place. The cement may be forced through a lower end of the casing and into an annulus between the casing and a wall of the wellbore (216). More specifically, a cementing plug may be used for pushing the cement from the casing. For example, the cementing plug may be a rubber plug used to separate cement slurry from other fluids, reducing contamination and maintaining predictable slurry performance. A displacement fluid, such as water, or an appropriately weighted drilling fluid, may be pumped into the casing above the cementing plug. This displacement fluid may be pressurized fluid that serves to urge the cementing plug downward through the casing to extrude the cement from the casing outlet and back up into the annulus.

As further shown in FIG. 2, sensors (221) may be included in a sensor assembly (223), which is positioned adjacent to a drill bit (224) and coupled to the drill string (215). Sensors (221) may also be coupled to a processor assembly that includes a processor, memory, and an analog-to-digital converter (222) for processing sensor measurements. For example, the sensors (221) may include acoustic sensors, such as accelerometers, measurement microphones, contact microphones, and hydrophones. Likewise, the sensors (221) may include other types of sensors, such as transmitters and receivers to measure resistivity, gamma ray detectors, etc. The sensors (221) may include hardware and/or software for generating different types of well logs (such as acoustic logs or density logs) that may provide well data about a wellbore, including porosity of wellbore sections, gas saturation, bed boundaries in a geologic formation, fractures in the wellbore or completion cement, and many other pieces of information about a formation. If such well data is acquired during drilling operations (i.e., logging-while-drilling), then the information may be used to make adjustments to drilling operations in real-time. Such adjustments may include rate of penetration (ROP), drilling direction, altering mud weight, and many others drilling parameters.

In some embodiments, acoustic sensors may be installed in a drilling fluid circulation system of a drilling system (200) to record acoustic drilling signals in real-time. Drilling acoustic signals may transmit through the drilling fluid to be recorded by the acoustic sensors located in the drilling fluid circulation system. The recorded drilling acoustic signals may be processed and analyzed to determine well data, such as lithological and petrophysical properties of the rock formation. This well data may be used in various applications, such as steering a drill bit using geosteering, casing shoe positioning, etc.

The control system (244) may be coupled to the sensor assembly (223) in order to perform various program functions for up-down steering and left-right steering of the drill bit (224) through the wellbore (216). More specifically, the control system (244) may include hardware and/or software with functionality for geosteering a drill bit through a formation in a lateral well using sensor signals, such as drilling acoustic signals or resistivity measurements. For example, the formation may be a reservoir region, such as a pay zone, bed rock, or cap rock.

Turning to geosteering, geosteering may be used to position the drill bit (224) or drill string (215) relative to a boundary between different subsurface layers (e.g., overlying, underlying, and lateral layers of a pay zone) during drilling operations. In particular, measuring rock properties during drilling may provide the drilling system (200) with the ability to steer the drill bit (224) in the direction of desired hydrocarbon concentrations. As such, a geosteering system may use various sensors located inside or adjacent to the drill string (215) to determine different rock formations within a well path. In some geosteering systems, drilling tools may use resistivity or acoustic measurements to guide the drill bit (224) during horizontal or lateral drilling.

In some embodiments, a user device (e.g., user device Y (190) may provide a graphical user interface (e.g., graphical user interface Y (191)) for communicating with an automated drilling manager, e.g., to monitor drilling operations, and drilling fluid operations. For example, a user device may be a personal computer, a human-machine interface, a smartphone, or another type of computer device for presenting information and obtaining user inputs in regard to the presented information. Likewise, the user device may obtain various user selections (e.g., shale shaker selection Y (192)) in regard to drilling operations, drilling fluid operations, and/or hole cleaning operations. Likewise, the user device may display various reports that may include charts as well as other arrangements of well data.

While FIGS. 1, 2, and 3 show various configurations of hardware components and/or software components, other configurations may be used without departing from the scope of the disclosure. For example, various components in FIGS. 1, 2, and 3 may be combined to create a single component. As another example, the functionality performed by a single component may be performed by two or more components.

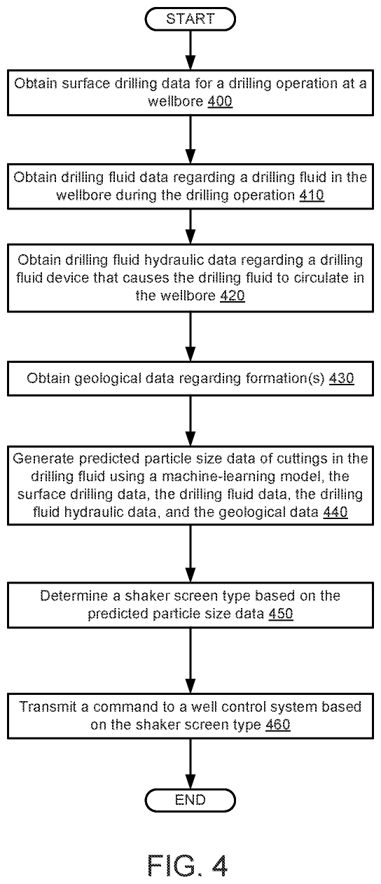

Turning to FIG. 4, FIG. 4 shows a flowchart in accordance with one or more embodiments. Specifically, FIG. 4 describes a general method for determining a shaker screen based on particle size data of drill cuttings. One or more blocks in FIG. 4 may be performed by one or more components (e.g., automated drilling manager (110)) as described in FIGS. 1, 2, and 3. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 400, surface drilling data are obtained regarding a drilling operation at a wellbore in accordance with one or more embodiments. Surface drilling data may include flow rate data (Q), rotary speed data (RS), and weight-on-bit data (WOB). For example, an automated drilling manager may obtain real-time surface drilling data regarding a drilling operation at a wellbore from various drilling sensors and other data sources.

In Block 410, drilling fluid data are obtained regarding a drilling fluid in the wellbore during a drilling operation in accordance with one or more embodiments. Drilling fluid data may include weight data (for example, mud weight, MW), plastic viscosity data (PV), and yield point data (Yp). For example, an automated drilling manager may collect drilling fluid data in real time from various sensors throughout a well site, e.g., from drilling fluid processing equipment as well as downhole in a wellbore.

In Block 420, drilling fluid hydraulic data are obtained regarding a drilling fluid device in accordance with one or more embodiments. Drilling fluid hydraulic data may include bit mechanical horsepower data (bit MHP), jet impact force data (F) and jet velocity data (V). For example, an automated drilling manager may obtain drilling fluid hydraulic data from relating weight data and viscosity data of the drilling fluid with characteristics of the drilling system.

In Block 430, geological data are obtained regarding one or more formations being traversed by the drilling operation in accordance with one or more embodiments. Geological data may include formation type data and rock drillability data (RD). Geological data may be based on well logs, core samples, and other sources.

In Block 440, predicted particle size data of cuttings in drilling fluid are generated using a machine-learning model, surface drilling data, drilling fluid data, drilling fluid hydraulic data, and geological data in accordance with one or more embodiments. After training a machine learning model using a training dataset, the machine-learning model may determine predicted particle size data of drilling cuttings during a drilling operation, such as the average drilling cuttings (i.e., a D50 value). Likewise, different machine-learning models may be used for other predicted particle size data, such as D90 data, D75 data, and D25 data. The machine-learning model may be integrated into a rate of penetration (ROP) model that is used in real time during a drilling operation. Once the drilling data for a particular depth interval is captured, the drilling data may be input to the ROP model to obtain an optimum ROP value.

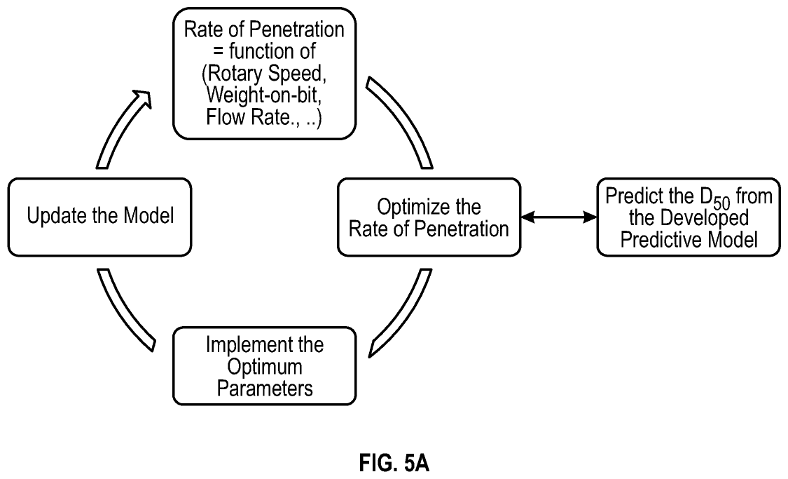

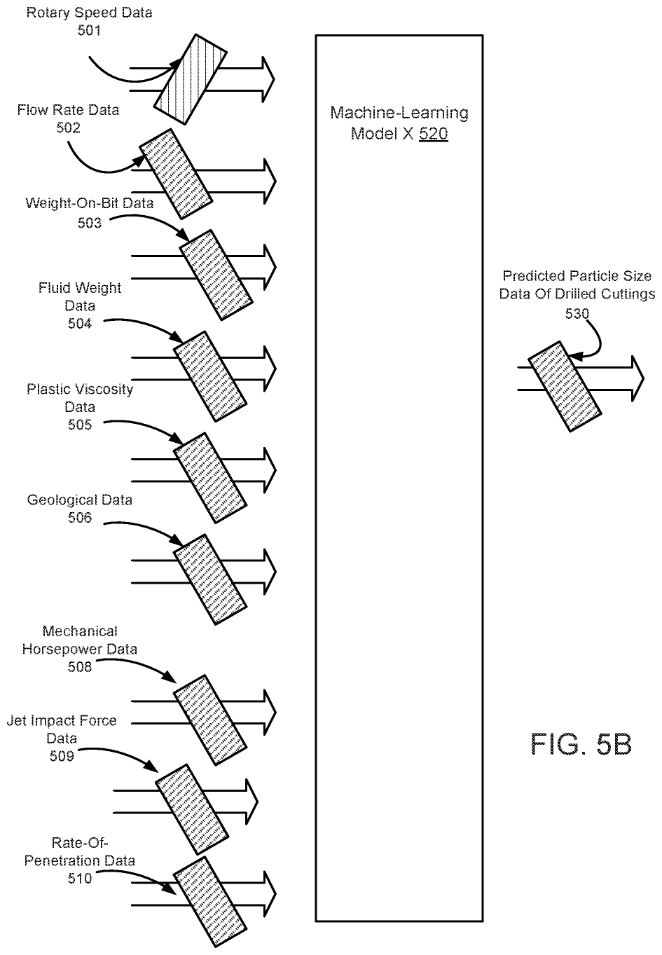

Before implementing the optimum parameters, the ROP value may be provided to a predictive D50 machine-learning model to determine an appropriate shale shaker screen size. If the predicted D50 is desirable, the current shale shaker may be replaced with a corresponding shale shaker screen that matches the optimum drilling parameters. If the predicted particle size data is not satisfactory, different drilling data may be input to the model until a desired predicted particle size is determined for the drilled cuttings. FIG. 5A provides one example of optimizing ROP data based on predicted particle size data. Furthermore, FIG. 5B shows an example of a machine-learning model for predicting particle size data of drilled cuttings in accordance with one or more embodiments. In FIG. 5B, a machine-learning model X (520) obtains as inputs rotary speed data (501), flow rate data (502), weight-on-bit data (503), fluid weight data (504), plastic viscosity data (505), geological data (506), mechanical horse power data (508), jet impact force data (509), and rate-of-penetration data (510) regarding a drilling operation. Using the input data, the machine-learning model X (520) determines predicted particle size data (530) of drilled cuttings for the drilling operation.

In some embodiments, a machine-learning model is used with a pre-drill model with optimum surface drilling parameters and fluid parameters that may lead to a certain D50 profile for each formation drilled. Based on the pre-determined D50 profile, an optimum shale shaker screen size may be used during a drilling operation. For example, a particular shale shaker screen may be installed prior to drilling commencing, or a solid removal system may automatically change to a particular shale shaker screen size.

In some embodiments, the machine-learning model data is trained using acquired cutting data from various training wells and corresponding well sections. For example, ten feet may be drilled in a new formation and, once the drilling cuttings reach the flow line before solid control equipment (SCE) or a solid removal system, cuttings may be retrieved. In particular, cuttings may be retrieved by a mud logger and divided into various wet-cut samples and dry-cut samples. After cleaning the cutting samples (e.g., sandstone and shale cuttings may require extra precautions when washing), the cutting samples may be analyzed for cutting data acquired from the particular training well, accordingly. If collecting cutting samples are needed at higher frequency for a training well, an additional mud logger may be assigned. For example, an automated drilling manager may be used to control various solid removal systems for collecting and sieving the cuttings. In some embodiments, training wells are selected based on a predetermined criterion, such as wells in similar formations with similar geological properties. Likewise, the criterion may correspond to wells with similar drilling operations (e.g., a similar type of drilling fluid, similar drilling parameters, etc.).

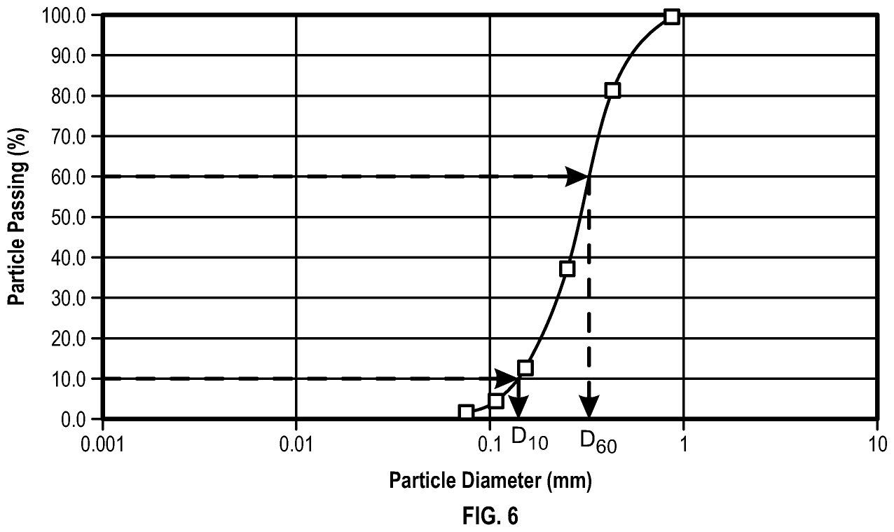

Turning to FIG. 6, FIG. 6 shows an example of particle size distribution curve according to one or more embodiments. The horizontal axis indicates the particle diameter (D) in millimeters, and the vertical axis indicates the percentage of particles that are not retained by a sieve corresponding to the particle diameter D. FIG. 6 illustrates how different particle sizes may be obtained from the particle size distribution curve. For example, starting by reading in the vertical axis the desired percentage of particles passing (or not retained by) the sieve with the desired particle diameter, the particle size distribution curve is intersected with a horizontal line. At the intersection of the particle size distribution curve, a vertical line is then projected towards the horizontal axis, providing the value of particle diameter corresponding to the desired percentage of particles passing. As seen, the particle sizes D10, and D60 are obtained from the particle size distribution curve of FIG. 6. Other desired particle sizes may be determined from the particle size distribution curve depending on their intended application.

Returning to FIG. 4, in Block 450, a shaker screen type is determined based on the predicted size particle data, wherein the shaker screen type corresponds to a predetermined cutting size in accordance with one or more embodiments. In some embodiments, an automated drilling manager may use the predicted size particle to determine a shaker screen type for an efficient removal of drilling cuttings. Alternatively, the shaker screen type may be selected by a user through a graphical user interface displaying the list of standardized shaker screen numbers. Accordingly, predicted particle size data may be used to determine shaker screen types in prewell planning as well as in recommending in real-time the optimal shaker screen type for removal of drilling cuttings. In some embodiments, a recommend screen size is presented on a user device based on one or more American Petroleum Institute (API) standards. As such, a user may provide a user selection to the user device of a chosen shaker screen type.

In Block 460, a command to a well control system is transmitted in accordance with one or more embodiments. The command may be configured to change a first shaker screen to a second shaker screen in a shale shaker device based on the shaker screen type. For example, an automated drilling manager may transmit a command to a well control system in order to recommend the drilling personnel a change in shaker screen. The use of the shaker screen type that is optimal to the drilling conditions may reduce the risk of any inefficient removal of drilled cuttings that may result in many problems for a drilling operation. For example, the content of drilling cuttings may affect the properties of the drilling fluid (e.g., density, viscosity, gel strengths, filter cake, inhibition levels, and lubricity). Potential problems that may arise due to high content of drilling cuttings include differential sticking incidents and even plug producing formations that may lead to complete loss of a well. An automated drilling manager may reduce the risks of impaired well productivity by assisting control systems and human personnel in maintaining the drilling fluid properties at their optimal values. Therefore, managing and controlling the content of drilling cuttings in the drilling fluid may become a significant aspect for optimizing a drilling operation.

In some embodiments, training data may also include other types of data collected for the well interval, such as, surface drilling data, drilling fluid data, drilling fluid hydraulic data, and geological data. Training data may be collected for other well intervals as the drilling operation continues until drilling the one or more formations is completed.

### Computer System

Embodiments may be implemented on a computer system. FIG. 7 is a block diagram of a computer system (702) used to provide computational functionalities associated with described algorithms, methods, functions, processes, flows, and procedures as described in the instant disclosure, according to an implementation. The illustrated computer (702) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (702) may include a computer that includes an input device, such as a keypad, keyboard, touch screen, or other device that can accept user information, and an output device that conveys information associated with the operation of the computer (702), including digital data, visual, or audio information (or a combination of information), or a GUI.

The computer (702) can serve in a role as a client, network component, a server, a database or other persistency, or any other component (or a combination of roles) of a computer system for performing the subject matter described in the instant disclosure. The illustrated computer (702) is communicably coupled with a network (730) or cloud. In some implementations, one or more components of the computer (702) may be configured to operate within environments, including cloud-computing-based, local, global, or other environment (or a combination of environments).

At a high level, the computer (702) is an electronic computing device operable to receive, transmit, process, store, or manage data and information associated with the described subject matter. According to some implementations, the computer (702) may also include or be communicably coupled with an application server, e-mail server, web server, caching server, streaming data server, business intelligence (BI) server, or other server (or a combination of servers).

The computer (702) can receive requests over network (730) or cloud from a client application (for example, executing on another computer (702)) and responding to the received requests by processing the said requests in an appropriate software application. In addition, requests may also be sent to the computer (702) from internal users (for example, from a command console or by other appropriate access method), external or third-parties, other automated applications, as well as any other appropriate entities, individuals, systems, or computers.

Each of the components of the computer (702) can communicate using a system bus (703). In some implementations, any or all of the components of the computer (702), both hardware or software (or a combination of hardware and software), may interface with each other or the interface (704) (or a combination of both) over the system bus (703) using an application programming interface (API) (712) or a service layer (713) (or a combination of the API (712) and service layer (713). The API (712) may include specifications for routines, data structures, and object classes. The API (712) may be either computer-language independent or dependent and refer to a complete interface, a single function, or even a set of APIs. The service layer (713) provides software services to the computer (702) or other components (whether or not illustrated) that are communicably coupled to the computer (702). The functionality of the computer (702) may be accessible for all service consumers using this service layer. Software services, such as those provided by the service layer (713), provide reusable, defined business functionalities through a defined interface. For example, the interface may be software written in JAVA, C++, or other suitable language providing data in extensible markup language (XML) format or other suitable format. While illustrated as an integrated component of the computer (702), alternative implementations may illustrate the API (712) or the service layer (713) as stand-alone components in relation to other components of the computer (702) or other components (whether or not illustrated) that are communicably coupled to the computer (702). Moreover, any or all parts of the API (712) or the service layer (713) may be implemented as child or sub-modules of another software module, enterprise application, or hardware module without departing from the scope of this disclosure.

The computer (702) includes an interface (704). Although illustrated as a single interface (704) in FIG. 7, two or more interfaces (704) may be used according to particular needs, desires, or particular implementations of the computer (702). The interface (704) is used by the computer (702) for communicating with other systems in a distributed environment that are connected to the network (730). Generally, the interface (704 includes logic encoded in software or hardware (or a combination of software and hardware) and operable to communicate with the network (730) or cloud. More specifically, the interface (704) may include software supporting one or more communication protocols associated with communications such that the network (730) or interface's hardware is operable to communicate physical signals within and outside of the illustrated computer (702).

The computer (702) includes at least one computer processor (705). Although illustrated as a single computer processor (705) in FIG. 7, two or more processors may be used according to particular needs, desires, or particular implementations of the computer (702). Generally, the computer processor (705) executes instructions and manipulates data to perform the operations of the computer (702) and any algorithms, methods, functions, processes, flows, and procedures as described in the instant disclosure.

The computer (702) also includes a memory (706) that holds data for the computer (702) or other components (or a combination of both) that can be connected to the network (730). For example, memory (706) can be a database storing data consistent with this disclosure. Although illustrated as a single memory (706) in FIG. 7, two or more memories may be used according to particular needs, desires, or particular implementations of the computer (702) and the described functionality. While memory (706) is illustrated as an integral component of the computer (702), in alternative implementations, memory (706) can be external to the computer (702).

The application (707) is an algorithmic software engine providing functionality according to particular needs, desires, or particular implementations of the computer (702), particularly with respect to functionality described in this disclosure. For example, application (707) can serve as one or more components, modules, applications, etc. Further, although illustrated as a single application (707), the application (707) may be implemented as multiple applications (707) on the computer (702). In addition, although illustrated as integral to the computer (702), in alternative implementations, the application (707) can be external to the computer (702).

There may be any number of computers (702) associated with, or external to, a computer system containing computer (702), each computer (702) communicating over network (730). Further, the term “client,” “user,” and other appropriate terminology may be used interchangeably as appropriate without departing from the scope of this disclosure. Moreover, this disclosure contemplates that many users may use one computer (702), or that one user may use multiple computers (702).

In some embodiments, the computer (702) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), artificial intelligence as a service (AlaaS), serverless computing, and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining surface drilling data for a drilling operation at a wellbore;
obtaining drilling fluid data regarding a drilling fluid in the wellbore during the drilling operation;
obtaining drilling fluid hydraulic data regarding a drilling fluid device that causes the drilling fluid to circulate in the wellbore;
obtaining geological data regarding one or more formations being traversed by the drilling operation;
generating, by a computer processor, predicted particle size data of cuttings in the drilling fluid using a machine-learning model, the surface drilling data, the drilling fluid data, the drilling fluid hydraulic data, and the geological data;
determining, by the computer processor, a shaker screen type based on the predicted particle size data, wherein the shaker screen type corresponds to a predetermined cutting size; and
transmitting, by the computer processor, a first command to a well control system, wherein the first command is configured to change a first shaker screen to a second shaker screen in a shale shaker device based on the shaker screen type.

2. The method of claim 1,
wherein the predicted particle size data describes a cutting size of a particle size distribution that splits a predetermined number of cuttings above the cutting size in the particle size distribution.

3. The method of claim 1, further comprising:
obtaining a selection of a plurality of training wells based on a predetermined criterion;
obtaining first training data and second training data for a first well among the plurality of training wells,
wherein the first training data correspond to a first plurality of cuttings at first well interval in the first well for a first formation,
wherein the second training data corresponds to a first plurality of cuttings at a second well interval different from the first well interval in the first well for the first formation; and
performing a training operation of the machine-learning model using the first training data and the second training data.

4. The method of claim 1, further comprising:
determining, in real-time during the drilling operation, a predetermined rate of penetration (ROP) value for a drill string coupled to a drilling system at the wellbore based on the predicted particle size data; and
transmitting a second command to the drilling system that produces the predetermined ROP value using the drill string.

5. The method of claim 1,
wherein the drilling fluid hydraulic data comprises bit mechanical horsepower data, jet impact force data and jet velocity data.

6. The method of claim 1,
wherein the drilling fluid data comprises plastic viscosity data and yield point data.

7. The method of claim 1,
wherein the surface drilling data comprises flow rate data, rotary speed data, and weight-on-bit data.

8. The method of claim 1,
wherein the geological data comprises formation type data.

9. The method of claim 1,
wherein the machine-learning model is a recurrent neural network.

10. The method of claim 1,
wherein the shale shaker device comprises a hopper, a feeder, a screen basket, and an electric motor configured to generate vibrations,
wherein the first shaker screen comprises a first mesh, and
wherein the second shaker screen comprises a second mesh that is different from the first mesh.

11. The method of claim 1,
wherein the first command is transmitted to the well control system prior to the drilling operation being initiated at the wellbore.

12. A system, comprising:
a drilling system comprising a drill string and a plurality of sensors, wherein the drilling system is coupled to a wellbore;
a mud pump system coupled to the wellbore, wherein the mud pump system is configured to supply a drilling fluid to the wellbore; and
a control system coupled to the drilling system and the mud pump system, wherein the control system comprises a computer processor, the control system is configured to perform a method comprising:
obtaining surface drilling data for a drilling operation at a wellbore;
obtaining drilling fluid data regarding a drilling fluid in the wellbore during the drilling operation;
obtaining drilling fluid hydraulic data regarding a drilling fluid device that causes the drilling fluid to circulate in the wellbore;
obtaining geological data regarding one or more formations being traversed by the drilling operation;
generating predicted particle size data of cuttings in the drilling fluid using a machine-learning model, the surface drilling data, the drilling fluid data, the drilling fluid hydraulic data, and the geological data;
determining a shaker screen type based on the predicted particle size data, wherein the shaker screen type corresponds to a predetermined cutting size; and
changing a first shaker screen to a second shaker screen in a shale shaker device based on the shaker screen type.

13. The system of claim 12, further comprising:
a user device coupled to the control system,
wherein the user device is configured to provide a graphical user interface for presenting a plurality of shale shaker screen types to a user and obtain one or more user selections in response to presenting the plurality of shale shaker screen types.

14. The system of claim 12,
wherein the predicted particle size data describes a cutting size of a particle size distribution that splits a predetermined number of cuttings above the cutting size in the particle size distribution.

15. The system of claim 12, wherein the method further comprises:
obtaining a selection of a plurality of training wells based on a predetermined criterion;
obtaining first training data and second training data for a first well among the plurality of training wells,
wherein the first training data correspond to a first plurality of cuttings at first well interval in the first well for a first formation,
wherein the second training data corresponds to a first plurality of cuttings at a second well interval different from the first well interval in the first well for the first formation; and
performing a training operation of the machine-learning model using the first training data and the second training data.

16. The system of claim 12, wherein the method further comprises:
determining, in real-time during the drilling operation, a predetermined rate of penetration (ROP) value for a drill string coupled to a drilling system at the wellbore based on the predicted particle size data; and
transmitting a command to the drilling system that produces the predetermined ROP value using the drill string.

17. The system of claim 12,
wherein the drilling fluid hydraulic data comprises bit mechanical horsepower data, jet impact force data and jet velocity data.

18. The system of claim 12,
wherein the drilling fluid data comprises plastic viscosity data and yield point data.

19. The system of claim 12,
wherein the surface drilling data comprises flow rate data, rotary speed data, and weight-on-bit data.

20. The system of claim 12,
wherein the geological data comprises formation type data.
